(19) United States
(12) Patent Application Publication
(10) Pub. No.: US 2014/0286331 A1
(43) Pub. Date: Sep. 25, 2014

(54) MULTI-TRAVERSAL METHOD FOR NAT IN BREAK-IN

(71) Applicant: NATIONAL TAIPEI UNIVERSITY OF TECHNOLOGY, Taipei (TW)

(72) Inventors: Shaw Hwa Hwang, Taipei (TW); Cheng Yu Yeh, Taipei (TW); Kuan Lin Chen, Taipei (TW); Yao Hsing Chung, Taipei (TW); Chi Jung Huang, Taipei (TW); Li Te Shen, Taipei (TW); Shun Chieh Chang, Taipei (TW); Bing Chih Yao, Taipei (TW); Chao Ping Chu, Taipei (TW); Ning Yun Ku, Taipei (TW); Tzu Hung Lin, Taipei (TW); Ming Che Yeh, Taipei (TW)

(73) Assignee: National Taipei University of Technology, Taipei (TW)

(21) Appl. No.: 13/855,043

(22) Filed: Apr. 2, 2013

(30) Foreign Application Priority Data
Mar. 22, 2013 (TW) 102110141

(51) Int. Cl. H04L 12/741

(52) U.S. Cl. CPC H04L 45/74
USPC 370/352

(57) ABSTRACT

In SIP network environment, a general traversal method for a port restricted NAT will become invalid when other users break in. The present invention provides four sessions for SIP, i.e. Login Session, Port Prediction Session, Multi-Traversal Session and Media Session, and the

SIP network environment includes a first Internet telephone, a second Internet telephone, a symmetric NAT, a port-restricted NAT and an SIP proxy server. In the Multi-Traversal Session, the second Internet telephone sends a plurality of identical speech packets to consecutive ports of the symmetric NAT through a fixed port of the port-restricted NAT so as to achieve the NAT traversal.

### FIELD OF THE INVENTION

The present invention relates to an NAT (Network Address Translator) traversal method, and more particularly to a traversal method for port-restricted NAT in break-in, in which a plurality of identical packets are sent for achieving traversal.

### BACKGROUND OF THE INVENTION

In current SIP (Session Initiation Protocol) Internet environment, setting up an NAT (Network Address Translator) server is very popular. But the Internet telephones under the NAT server cannot achieve P2P (Peer to Peer) transmission directly for speech packets, an SIP proxy server is needed to assist transmission.

In order to transmit speech packets directly, the Internet telephones have to traverse the NAT server. Related inventions for traversal the

NAT server are many, for example, Taiwan Invention Patent I 376133 (related US application is U.S. Ser. No. 12/382261) provides a plurality of registration before issuing an Invite message during registration session in SIP in order to detect the regular rule of the NAT server for allocating communication port, so that the following speech packets can utilize the regular rule to predict the allocated communication port for P2P transmission directly without passing through the SIP proxy server.

But the above-described traversal method will become invalid when a port-restricted NAT in break-in is met, it is described as below.

Referring to FIG. 1, in which a schematic diagram for direct packets transmission in SIP Internet environment is shown. An Internet telephone 1 and an Internet telephone 2 are under a symmetric NAT 3 and a port-restricted NAT 4 respectively. A packet comprises four parameters, i.e. source IP address, source communication port number, destination IP address, and destination communication port number. The Internet telephone 1 transmits a packet-1 to the Internet telephone 2, the packet-1 will become packet-1′ when passing through the symmetric NAT 3, and the source IP address VIP1 in the packet-1 will be converted into RIP 1, the source communication port number SP1 will be converted into SP1′, while the destination IP address RIP2 and the destination communication port number DP 1 remain unchanged. Similarly, The Internet telephone 2 transmits a packet-2 to the Internet telephone 1, the packet-2 will become packet-2′ when passing through the port-restricted NAT 4, and the source IP address VIP2 in the packet-2 will be converted into RIP2, the source communication port number SP2 will be converted into SP2′, while the destination IP address RIP1 and the destination communication port number DP2 remain unchanged. The packet-1′ and the packet-2′can be sent to the opposite side smoothly only when SP1′=DP2 and DP1=SP2′. SP1′ is designated by the symmetric NAT 3, SP2′ is designated by the port-restricted NAT 4. The designation or allocation of the communication port for NAT 3 is under a regular rule, while the communication port for NAT 4 is kept unchanged (this is the feature of the port-restricted NAT 4). The Taiwan Invention Patent I 376133 (related US application is U.S. Ser. No. 12/382261) is to provide a plurality of registration before issuing an Invite message during registration session in SIP in order to detect the regular rule of the NAT 3 for allocating communication port, and also detect if NAT 4 is a port-restricted NAT, so that the following packets can utilize the regular rule of NAT 3 to predict the allocated communication port for P2P transmission directly with the NAT 4.

If the symmetric NAT 3 and the port-restricted NAT 4 are put through, then the allocated communication port of NAT 3 and the unchanged communication port of NAT 4 will continue the P2P (Peer to Peer) transmission for packets. However, if someone 6 breaks in before the symmetric NAT 3 and the port-restricted NAT 4 are put through as shown in FIG. 2, the P2P (Peer to Peer) transmission for packets are destroyed. Referring to FIG. 2, Internet telephone 1 sends packet-1 to SIP proxy server 5 through NAT 3, the packet-1 is converted into the packet-1′ by NAT 3. Internet telephone 2 sends packet-2 to SIP proxy server 5 through the port-restricted NAT 4, the packet-2 is converted into the packet-2′ by NAT 4. Both sides utilize a port predictive technique (for example, Taiwan Invention Patent I 376133, related US application is U.S. Ser. No. 12/382261) to detect that NAT 3 has a regular rule for allocating communication port, and that NAT 4 is port-restricted, at this time the communication port for NAT 3 is A and the communication port for NAT 4 is B. At the next step to transmit speech packets, the communication port for NAT 3 is increased to A+1, the communication port for NAT 4 is still B, at this time, if someone 6 breaks in with packet-3 to occupy the communication port A+1, then the speech packet-4 of Internet telephone 1 is forced to use communication port A+2 according to the allocating rule of NAT 3. The speech packet-4 is converted into speech packet-4′ by NAT 3 for being sent to the communication port B. However, speech packet-5 from Internet telephone 2 are converted into speech packet-5′ by NAT 4 and sent to communication port A+1. Therefore both sides of NAT 3 and NAT 4 cannot transmit speech packets with each other due to the communication ports are not the same.

### SUMMARY OF THE INVENTION

In order to solve the port missing problem for port-restricted NAT as described above, the present invention provides a “multi-traversal session” in SIP for achieving traversal.

The present invention sets up a registration session, a communication port prediction session, a multi-traversal session and a media session for SIP, and the Internet environment for SIP comprises a first Internet telephone, a second Internet telephone, a symmetric NAT, a port-restricted NAT, and an SIP proxy server; the first Internet telephone is under the symmetric NAT, the second Internet telephone is under the port-restricted NAT; a traversal method comprises:

the first Internet telephone and the second Internet telephone register on the SIP proxy server firstly to accomplish the registration session;

the first Internet telephone conducts a plurality of detection procedure to the the symmetric NAT for detecting the regular rule of allocating communication port by the symmetric NAT; the second Internet telephone conducts a plurality of detection procedure to the port-restricted NAT for determining that the port-restricted NAT is port-restricted; so as to accomplish the communication port prediction session;

thereafter the multi-traversal session is entered, the first Internet telephone sends a speech packet to a fixed communication port of the port-restricted NAT through a communication port of the symmetric NAT; the second Internet telephone sends a plurality of identical speech packets to consecutive communication ports of the symmetric NAT through the fixed communication port of the port-restricted NAT;

if there is someone breaks in to occupy the communication port of the symmetric NAT before the first Internet telephone sends a speech packet to the fixed port of the port-restricted NAT through the communication port of the symmetric NAT, then the speech packet sent by the first Internet telephone can only use a next communication port of the symmetric NAT for arriving the fixed communication port of the port-restriced NAT; since the second Internet telephone sends a plurality of identical speech packets to consecutive communication ports of the symmetric NAT through the fixed communication port of the port-restricted NAT, one of the the plurality of identical speech packets sent by the second Internet telephone must meet the speech packet sent by the first Internet telephone, therefore both sides enter the media session for conducting speech communication.

### BRIEF DESCRIPTION OF THE DRAWINGS

FIG. 1 shows schematically a direct packet transmission in SIP Internet environment.

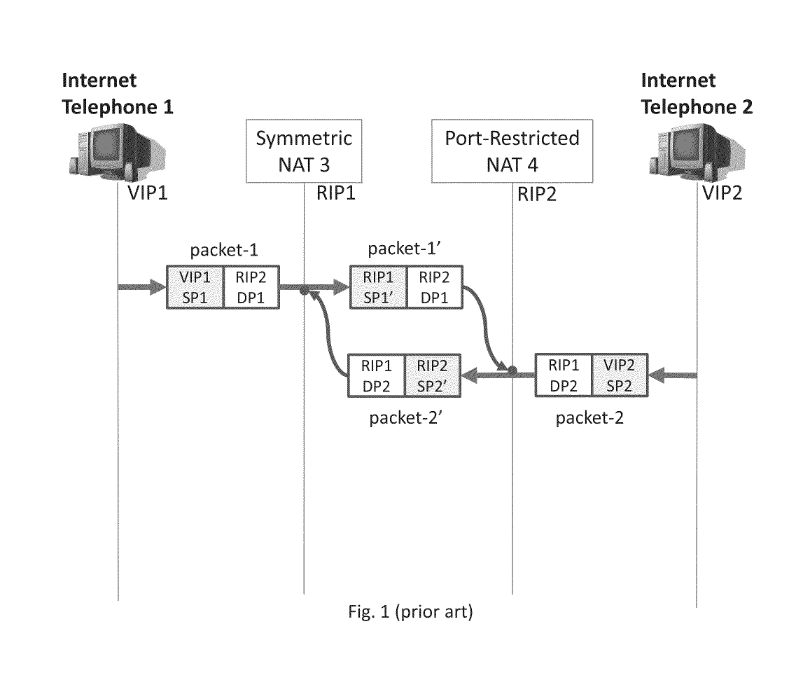

FIG. 2 shows schematically that there is a packet of someone breaks in to occupy the communication port A+1.

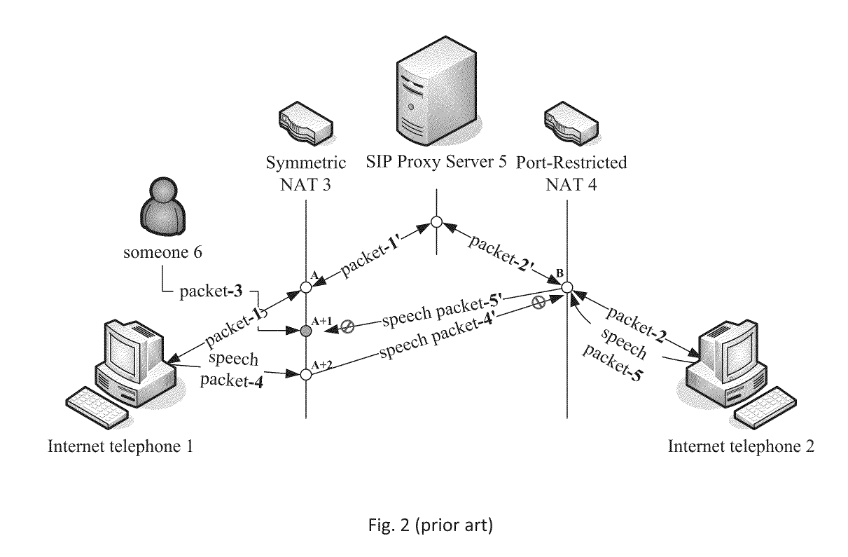

FIG. 3 shows schematically the registration session and the communication port prediction session.

FIG. 4 shows schematically the second Internet telephone sends a plurality of identical speech packets to consecutive communication ports of the symmetric NAT through the fixed communication port of the port-restricted NAT.

### DETAILED DESCRIPTIONS OF THE PREFERRED EMBODIMENTS

The present invention sets up a registration session, a communication port prediction session, a multi-traversal session and a media session for SIP, and the Internet environment for SIP comprises a first Internet telephone 1, a second Internet telephone 2, a symmetric NAT 3, a port-restricted NAT 4, and an SIP proxy server 5; the first Internet telephone 1 is under the symmetric NAT 3, the second Internet telephone 2 is under the port-restricted NAT 4.

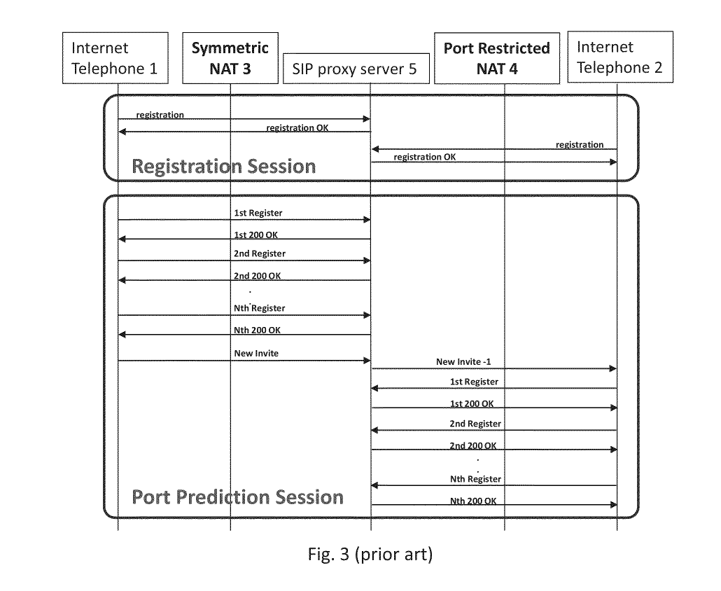

The registration session and the communication port prediction session are shown in FIG. 3. Referring to FIG. 3, an Internet telephone 1 and an Internet telephone 2 register on the SIP proxy server 5 firstly to accomplish the registration session.

Thereafter the communication port prediction session is entered. Internet telephone 1 uses “Register” request to conduct a plurality of detection for detecting the regular rule of allocating communication port by the symmetric NAT 3. After the plurality of detection, the Internet telephone 1 can predict the port number allocated by the NAT3 for being used as the speech packets transmission channel.

Next, the Internet telephone 1 sends “New Invite” request to the SIP proxy server 5 through the symmetric NAT 3, the SIP proxy server 5 will then send “New Invite-1” request to the Internet telephone 2 through the port-restricted NAT 4.

After the Internet telephone 2 receives the “New Invite-1” request, the Internet telephone 2 uses “Register” request to conduct a plurality of detection for detecting the regular rule of allocating communication port by the symmetric NAT 4. After the plurality of detection, the Internet telephone 2 can predict the communication port allocated by the NAT4 is fixed.

Therefore, during transmission of speech packet, the Internet telephone 2 will use the fixed communication port allocated by the port-restricted NAT 4 for speech packet transmission. The communication port prediction session is therefore accomplished. There are many other methods for communication port prediction. The method described above is an example from Taiwan Invention Patent I 376133 (related US application is U.S. Ser. No. 12/382261).

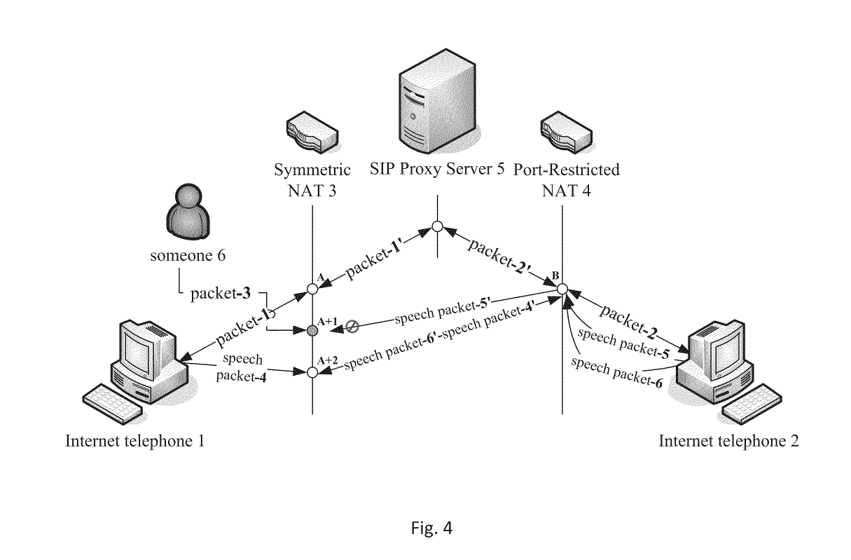

Referring to FIG. 4, the communication port prediction session is just finished, the communication port of the NAT 3 is A, the communication port of NAT 4 is B. At the next step to transmit speech packet, the communication port of NAT 3 will be A+1, while the communication port of NAT 4 is still B. At this time, there is someone 6 breaks in with packet-3 to occupy the communication port A+1, then the speech packet-4 of Internet telephone 1 is forced to use communication port A+2 according to the allocating rule of NAT 3. The speech packet-4 is converted into speech packet-4′ by NAT 3 for being sent to the communication port B. Internet telephone 2 will send two identical speech packets-5 and speech packet-6. The speech packet-5 is converted into speech packet-5′ through NAT 4 for being sent to the communication port A+1; the speech packet-6 is converted into speech packet-6′ for being sent to the communication port A+2. Thus the speech packet-4′ meets with the speech packet-6′ through communication port A+2 and communication port B, both sides can therefore enter the media session for communication.

If there are two persons to break in, then the Internet telephone has to send three identical speech packet-5, speech packet-6, and speech packet-7. Although the speech packet-5 and the speech packet-6 are invalid for speech communication, the speech packet-7 can meet with the speech packet 4 successfully for speech communication. The rest may be inferred by analogy.

The scope of the present invention depends upon the following claims, and is not limited by the above embodiments.

What is claimed is:

1. A multi-traversal method for NAT in break-in, a registration session, a communication port prediction session, a multi-traversal session and a media session are set up for SIP, and the Internet environment for SIP comprises a first Internet telephone, a second Internet telephone, a symmetric NAT, a port-restricted NAT, and an SIP proxy server; the first Internet telephone is under the symmetric NAT, the second Internet telephone is under the port-restricted NAT, said method comprises:
a. the first Internet telephone and the second Internet telephone register on the SIP proxy server firstly to accomplish the registration session;
b. the first Internet telephone conducts a plurality of detection procedure to the the symmetric NAT for detecting the regular rule of allocating communication port by the symmetric NAT;
the second Internet telephone conducts a plurality of detection procedure to the port-restricted NAT for detecting that the port-restricted NAT has a fixed communication port; so as to accomplish the communication port prediction session;
c. thereafter the multi-traversal session is entered, the first Internet telephone sends a speech packet to a fixed communication port of the port-restricted NAT through a communication port of the symmetric NAT; the second Internet telephone sends a plurality of identical speech packets to consecutive communication ports of the symmetric NAT through the fixed communication port of the port-restricted NAT;
d. if there is someone breaks in to occupy the communication port of the symmetric NAT before the first Internet telephone sends a speech packet to the fixed port of the port-restricted NAT through the communication port of the symmetric NAT, then the speech packet sent by the first Internet telephone can only use a next communication port of the symmetric NAT for arriving the fixed communication port of the port-restriced NAT; since the second Internet telephone sends a plurality of identical speech packets to consecutive communication ports of the symmetric NAT through the fixed communication port of the port-restricted NAT, one of the plurality of identical speech packets sent by the second Internet telephone must meet the speech packet sent by the first Internet telephone, therefore both sides enters the media session for conducting speech communication.
